(19) United States
(12) Patent Application Publication
(10) Pub. No.: US 2025/0358647 A1
(43) Pub. Date: Nov. 20, 2025

(54) METHODS, ARCHITECTURES, APPARATUSES AND SYSTEMS FOR PROTOCOL DATA UNIT SESSION HANDOVER FOR DUALSTEER DEVICES

(71) Applicant: InterDigital Patent Holdings, Inc., Wilmington, DE (US)

(72) Inventors: Taimoor Abbas, Sainte-Julie (CA); Anuj Sethi, Ottawa (CA); Xavier De Foy, Kirkland (CA); Rocco Di Girolamo, Laval (CA); Guanzhou Wang, Brossard (CA); Magurawalage Chathura Madhusanka Sarathchandra, London (GB); Michelle Perras, Montreal (CA)

(21) Appl. No.: 18/666,625

(22) Filed: May 16, 2024

(51) Int. Cl. H04W 24/08; H04W 76/30

(52) U.S. Cl. CPC H04W 24/08; H04W 76/30

(57) ABSTRACT

A method performed by a wireless transmit/receive unit (WTRU). The WTRU comprises a first mobile termination (MT) and a second MT. The first MT and second MT are each in a protocol data unit (PDU) session with a network. The method comprises: identifying a condition affecting the PDU session of the second MT and in response to identifying the condition, releasing the PDU session of the second MT, selecting, using the second MT, a new network and requesting, using the second MT, a PDU session with the new network.

### BACKGROUND

The present disclosure is generally directed to the fields of communications, software and encoding, including, for example, to methods, architectures, apparatuses, systems related to protocol data unit session handover for DualSteer devices.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a dual-MT device;

FIG. 3A illustrate a DualSteer WTRU according to one or more embodiments;

FIG. 3B illustrate a DualSteer WTRU according to one or more embodiments;

FIG. 3C illustrate a DualSteer WTRU according to one or more embodiments;

FIG. 3D illustrate a DualSteer WTRU according to one or more embodiments;

FIG. 4 is a sequence diagram illustrating an example of PDU session handover for a DualSteer WTRU;

FIG. 5 is a sequence diagram illustrating an example of a PDU session handover for a DualSteer WTRU;

FIG. 6 is a procedural diagram illustrating a method for PDU session management according to one or more embodiments; and

FIG. 7 is a procedural diagram illustrating a process for traffic management according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

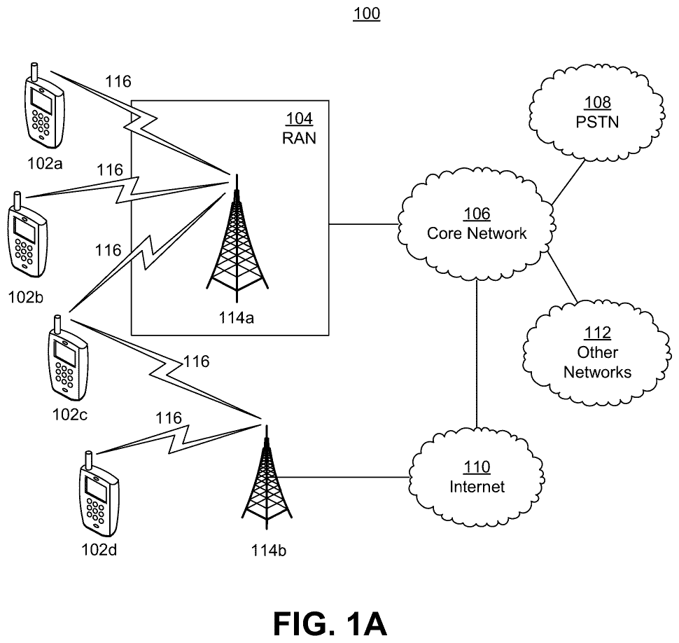

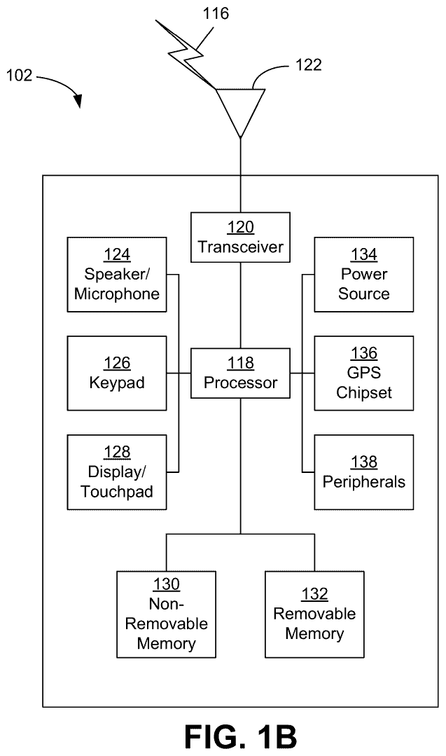

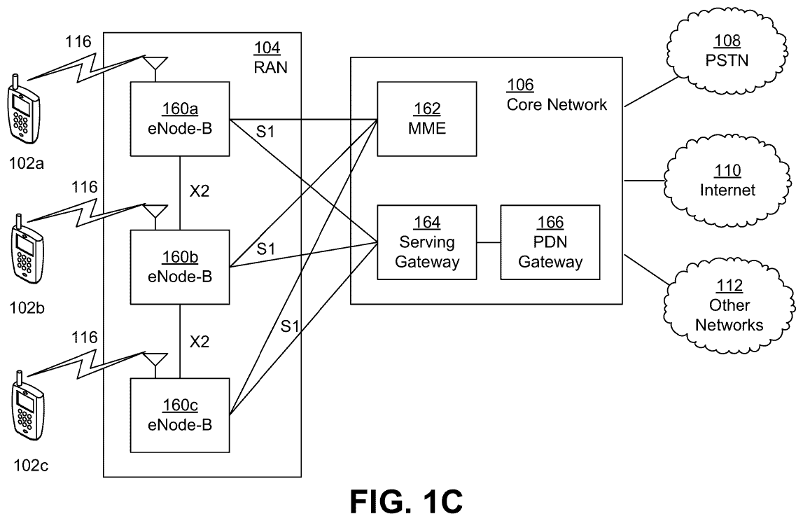

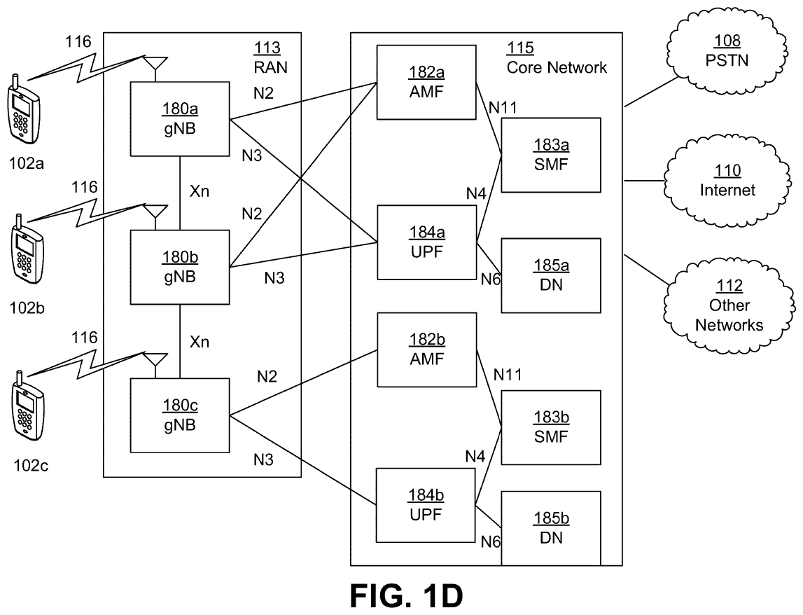

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### OVERVIEW

In certain representative embodiments, a procedure is provided to trigger PDU session management in roaming scenarios, i.e., release, handover, or modification, based on a trigger such as QoS drop, out-of-coverage etc.

In certain representative embodiments, a UE is enabled to register and request PDU session on behalf of two UEs within a DualSteer WTRU.

In certain representative embodiments, methods are provided to suspend, move or pause a PDU session based on the condition and the requirements for one of the two UEs within a DualSteer WTRU.

### Session and Mobility Management

In certain representative embodiments, WTRUs may provide both their Session Management (SM) and Mobility Management (MM) capability to a core network. A WTRU may send the WTRU MM Core Network Capability information to the Access and Mobility management Function (AMF) during an Initial Registration procedure and Mobility Registration Update procedure, within a Non-Access Stratum (NAS) message. Similarly, a WTRU may include its 5GSM Core Network Capability in PDU Session Establishment/Modification Requests. These latter messages include the WTRU's Access Traffic Steering, Switching and Splitting (ATSSS) capabilities.

In certain representative embodiments, WTRUs may be required to perform registration to a network if they need to access services requiring registration. In order to perform this registration, the WTRU may perform at least one of the steps below:

1. Public Land Mobile Network (PLMN) selection or Standalone Non-Public Network (SNPN) selection—procedure by which a WTRU selects a mobile network. This network may be a public network or a non-public network. The WTRU may follow rules to determine how to select from the available networks at a given location, and to determine when to look for higher priority networks.

2. Cell selection/reselection—procedure by which WTRU “camps” on a cell.

3. Registration—procedure to inform network about the WTRU presence and provide some coarse location information and capability exchange and negotiations.

In certain representative embodiments, a DualSteer WTRU supports traffic steering and switching of user data (for different services) across two 3GPP access networks. A DualSteer WTRU may send its user data over two 3GPP access networks belonging to the same Public Land Mobile Network (PLMN) or different PLMN, either non-simultaneously or simultaneously.

In case of non-simultaneous data transmission over two networks, a DualSteer WTRU may be a single UE. In case of simultaneous data transmission over two networks DualSteer WTRU may have two separate UEs with two Universal Subscriber Identity Modules (USIMs), The UEs may be either co-located, or may be physically separated but interlinked. In Multi-USIM (MUSIM) operation the two USIMs in a WRTU may run independently of each other.

### Splitting Traffic Across Two 3GPP Access Legs

In certain representative embodiments, Carrier aggregation may be provided over a single 3GPP access (for example New Radio (NR) or Long Term Evolution (LTE)), but allows the WTRU to receive over two or more cells. The cells may be each on a different frequency carriers. The use of the two cells may be managed entirely in the Radio Access Networks (RAN).

In certain representative embodiments, WTRUs may support Dual Connectivity (DC). DC allows a WTRU to receive/transmit over two 3GPP accesses (or 3GPP access legs). The accesses may be NR (gNB) or LTE (eNB). In certain representative embodiments, one leg may be over LTE and a second leg may be over NR. In certain representative embodiments, DC may also support two legs over NR. In this case, the two legs may be on different bands (e.g., FR1 and FR2). In order to employ DC, a WTRU may need the Radio Frequency (RF) front end to support both accesses. In dual connectivity, one leg is the master leg (and part of a Master Cell Group (MCG)), and the other leg is the secondary leg (and part of a Secondary Cell Group (SCG))

For the PLMN plus PLMN/NPN (Public Land Mobile Network/Non-Public Network) scenarios, the two networks may be managed by the same operator or by different operators.

### Traffic Steering and Switching Over Two 3GPP Access Networks

Mechanisms that enable traffic steering, switching and splitting between a 3GPP access network (e.g., E-UTRA or NR) and a non-3GPP access network (e.g., WiFi) are provided. The mechanism may be an ATSSS.

In certain representative embodiments, a DualSteer WTRU may support traffic steering and switching of user data (for different services) across two 3GPP access networks. The DualSteer WTRU may be (a) a single UE, in case of non-simultaneous data transmission over the two networks, or (b) two separate UEs in case of simultaneous data transmission over the two networks. The subscriber of the DualSteer WTRU may have two Subscription Permanent Identifiers/SUPIs, sharing one subscription profile from the same operator. For any particular service, at any given time, the DualSteer WTRU may transmit all traffic of that service using only a single 3GPP access network.

There are various scenarios of two 3GPP access types (e.g., NR, Non-Terrestrial NR, E-UTRA) and the network types (e.g., H-PLMN, V-PLMN, PNI-NPN) that the 3GPP access networks may be connected to.

In certain representative embodiments, requirements for supporting DualSteer may be at least one of:
a “DualSteer WTRU” may use two SUPIs from the same operator for accessing two separate 3GPP access networks. And each SUPI may be used to connect to only one of the 3GPP access networks at any given time.
a “DualSteer WTRU” may send its user data over two 3GPP access networks belonging to the same PLMN, either non-simultaneously or simultaneously.
a “DualSteer WTRU” may send its user data over two 3GPP access networks belonging to two different PLMNs, either non-simultaneously or simultaneously.
in case of non-simultaneous data transmission over two networks, a “DualSteer WTRU” may be a single UE. In case of simultaneous data transmission, a “DualSteer WTRU” may be “two separate UEs”.
in case of simultaneous data transmission, the data over two separate networks may belong to different services (or different Service Data Flows).
At any given point of time, all traffic of a single service may be sent over a single access network, i.e., no service data splitting.

### WTRU Identities

In certain representative embodiments, the Subscription Permanent Identifier (SUPI) may be a 5G globally unique identifier allocated to each subscriber. The SUPI may be value is provisioned in Universal Subscriber Identity Module (USIM) and Unified Data Management/User Data Repository (UDM/UDR) function in 5G Core. The SUPI may be either an International Mobile Subscriber Identifier (IMSI) or a Network Access Identifier (NAI). For the IMSI version of the SUPI, the first three digits may represent the Mobile Country Code (MCC), the next two or three may represent the Mobile Network Code (MNC) identifying the network operator or PLMN. The remainder may represent the Mobile Subscriber identification number (MSIN).

Subscription Concealed Identifier (SUCI) is a privacy preserving identifier containing the concealed SUPI. The SUCI may include the PLMN ID of the home network (in MCC and MNC). The MCC/MNC may be transmitted in plain text.

The 5G GUTI (Globally Unique Temporary Identifier) may be allocated by the AMF (Access and Mobility Management Function). The AMF may assign a new 5G-GUTI to the WTRU at any time. The 5G-GUTI may comprise a GUAMI (Globally Unique AMF ID) and a 5G-TMSI (Temporary Mobile Subscriber Identity), where GUAMI identifies the assigned AMF and 5G-TMSI identifies the WTRU uniquely within the AMF. The GUAMI is a concatenation of the PLMN ID and the AMF identifier.

### MUSIM Operation

A WTRU may have multiple USIMs that are in operation at the same time, where each USIM allows the WTRU to obtain service from a different mobile network. A typical use case for MUSIM devices is for professionals who needed a business number and a separate personal number. Instead of carrying two phones, these professionals could use a single phone with two USIM cards.

The terminal behaviour with respect to the simultaneous handling of multiple USIMs may depend on the WTRU capabilities (e.g. WTRU with single Rx/single Tx vs WTRU with dual Rx/single Tx vs WTRU with dual Rx/dual Tx), wherein dual Rx allows a MUSIM WTRU to simultaneously receive traffic from two networks, single RX allows MUSIM WTRU to receive traffic from one network at one time, and single Tx allows MUSIM WTRU to transmit traffic to one network at one time.

Typically, the two USIMs may run independently of each other. Each USIM may require that the WTRU have a dedicated Non-Access Stratum and Access Stratum protocol stacks. However, depending on the capabilities of the WTRU, some coordination may be needed to allow the WTRU to obtain service to both mobile networks. The WTRU may act like a mediator between the two mobile networks.

Herein, subscriptions may be designated to two network operators through a MUSIM device as a “dual subscription”, while each distinct subscription may be designated to a network operator, not involving a MUSIM device, as a “single subscription”.

### Inter-PLMN Mobility

The AMF may use the N14 interface for AMF re-allocation and AMF to AMF information transfer. This interface may be either intra-PLMN or inter-PLMN (e.g., in the case of inter-PLMN mobility).

At inter-PLMN mobility, the source AMF may select an AMF instance(s) in the target PLMN by querying target PLMN level NRF via the source PLMN level NRF with target PLMN ID. The target PLMN level NRF may return an AMF instance address based on the target operator configuration. After the Handover procedure the AMF may select a different AMF.

A UE may be a device allowing a user access to network services. The interface between the UE and a network may be a radio interface. The UE may be subdivided into a number of domains. The domains may include a Universal Subscriber Identity Module (USIM) and Mobile Equipment (ME) domains. The ME Domain may be further subdivided into several components e.g., a Terminal Equipment (TE) and Mobile Termination (MT) domains. The following embodiments are described primarily by using the term “Mobile Termination (MT)”, it should be noted that this is exemplary and a person skilled in the art understands that the term MT is interchangeable with term “UE” throughout the description.

### Dual-MT Device Model

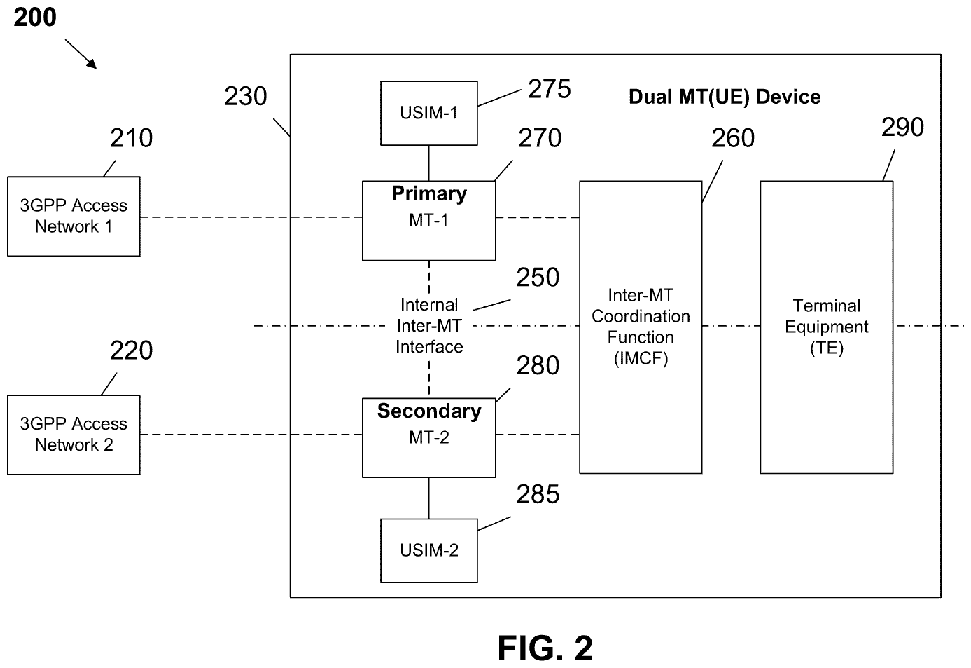

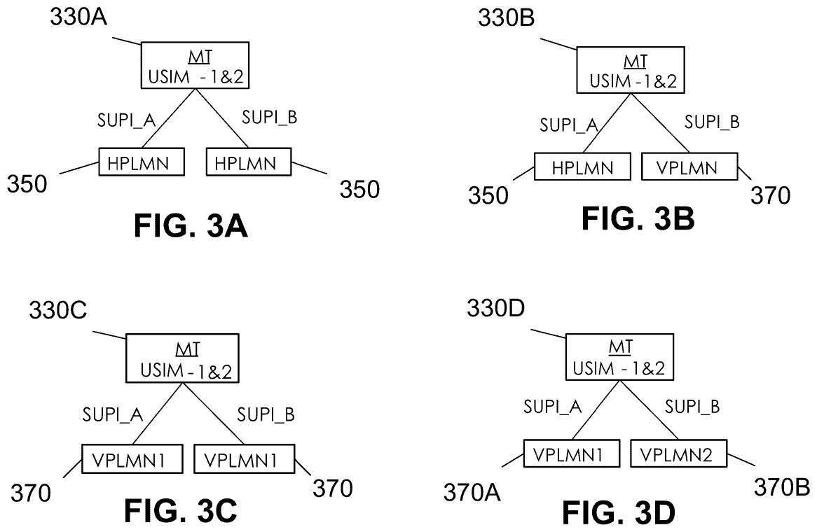

FIG. 2 is a diagram illustrating an example of a dual-Mobile Termination WTRU (dual-MT WTRU). In certain representative embodiments, a WTRU may have two separate mobile terminations (MTs) and USIMs. For example, each MT may provide one or more functionalities that are in an MT of a UE (e.g., at least one of radio transmission, radio reception, baseband signal processing, access to USIM, access to CP stack, access to UP stack, combinations of the same, or the like). A common Terminal Equipment (TE) may be provided (as shown, for example, in FIG. 3). In certain representative embodiments, two separate TEs corresponding to two MTs may be provided. An internal inter-MT interface between two MTs may be provided. The internal inter-MT interface may be configured to allow two MTs to exchange information. For example, two MTs may exchange information through a higher layer “Inter-MT Coordination Function (IMCF)”. Two MTs may be identified by two unique device identifiers such as IMEIs. An additional ID called DualSteer specific UE ID (DS-specific-UE-ID) may be used to interlink the Primary and Secondary MT in a dual-MT device.

In certain representative embodiments, as illustrated in the example of FIG. 2, a system 200 is provided. The system 200 may include a dual-MT device 230 configured to communicate with a first 3GPP access network 210 and/or a second 3GPP access network 220. The dual-MT device 230 may include a first or primary MT 270 and a second or secondary MT 280. The first or primary MT 270 and the second or secondary MT 280 may communicate, e.g., via an internal inter-MT interface 250. The first or primary MT 270 may have a first USIM 275. The second or secondary MT 280 may have a second USIM 285.

For example, an Inter-MT Coordination Function (IMCF) 260 may be provided. The IMCF 260 may be provided in the higher layer. The IMCF 260 may be part of a TE 290. The communication between MTs or between the MT and the IMCF 260 may use AT commands. Two MTs may be identified by two unique device identifiers such as International Mobile Equipment Identities (IMEIs).

Both MTs may have a separate subscription for registering to mobile network. Primary MT may Register to a PLMN at first, and the Secondary MT 280 may Register only when it is triggered by the Primary MT directly or via the IMCF layer 260. An MT in a DualSteer capable WTRU may include the Information of primary or secondary MT as part of its Registration Request message and send it to the network.

In certain representative embodiments, a DualSteer WTRU comprises two UEs. In certain representative embodiments, a DualSteer WTRU comprises a single UE with two stacks. In certain representative embodiments, a DualSteer WTRU comprises two MTs. For example, the DualSteer WTRU may comprise two subscriptions that are interlinked for the DualSteer WTRU, i.e., two SUPIs, namely SUPI_A and SUPI_B. In certain representative embodiments, a Linked SUPI or a DualSteer specific UE ID, which is known to both MTs and also known to the PLMN and stored in the UDM may be provided.

In certain representative embodiments, a DualSteer WTRU comprises two MTs and two subscriptions. With reference to FIGS. 3A to 3D, embodiments for a non-roaming, roaming with local break-out or home-routed roaming are provided and described herein.

FIG. 3A illustrate a DualSteer WTRU 330A in a non-roaming configuration according to one or more embodiments. The DualSteer WTRU 330 may comprise two separate MTs (MT1, MT22) with two Universal Subscriber Identity Modules (USIM-1, USIM-2). In this embodiment MT1 (SUPI_A) and MT2 (SUPI_B) may be served by one Home PLMN 350 (HPLMN).

FIG. 3B illustrate a DualSteer WTRU 330B in a home routed roaming configuration according to one or more embodiments. The DualSteer WTRU 330B may comprise two separate MTs (MT1, MT2) with two Universal Subscriber Identity Modules (USIM-1, USIM-2). In this embodiment MT1 (SUPI_A) may be served by an HPLMN 350 and MT2 (SUPI_B) may served by a Visitor PLMN (VPLMN) 370.

FIG. 3C illustrate a DualSteer WTRU 330C in a home routed roaming configuration according to one or more embodiments. The DualSteer WTRU 330C may comprise two separate MTs (MT1, MT2) with two Universal Subscriber Identity Modules (USIM-1, USIM-2). In this embodiment MT1 (SUPI_A) and MT2 (SUPI_B) may be served by one VPLMN 370.

FIG. 3D illustrate a DualSteer WTRU 330D in a home routed roaming configuration according to one or more embodiments. The DualSteer WTRU 330D may comprise two separate MTs (MT1, MT2) with two Universal Subscriber Identity Modules (USIM-1, USIM-2). In this embodiment MT1 (SUPI_A) may be served by a first VPLMN (VPLMN1) 370A and UE2 (SUPI_B) may served by a second VPLMN (VPLMN2) 370B.

With reference to FIGS. 3A to 3D, when the PDU sessions for SUPI_A and SUPI_B are established with each respective PLMNs, for example according to any one of HPLMN, VPLMN, VPLMN1, VPLMN2 combinations in FIGS. 3A to 3D or any other combination thereof. When an MT in the DualSteer WTRU experiences a condition, for example at least one of a steering mode can no longer be supported, MT moves out of coverage, the QoS drops, or the slice becomes unavailable and others, with the MT's PLMN. The PDU sessions for each MT1 and MT2 may be established with a different VPLMNs, e.g., MT1 with VPLMN1 and MT2 with VPLMN2.

The PDU session of SUPI_A or SUPI_B when the respective MT in a DualSteer WTRU experiences a condition, e.g., QoS drop, with its respective PLMN may be handled according to one or more embodiments.

The PDU session of the first and/or second MT may be released when the condition is true according to one or more embodiments.

When the PDU session is released, a new PDU session may be established according to one or more embodiments.

An on-going PDU session of the first or second MT is transferred to the other MT within the DualSteer WTRU according to one or more embodiments.

The PDU session may be transferred and the PDU session establishment/modification procedure may be updated according to one or more embodiments.

In certain representative embodiments, a first MT may comprise a SUPI_A and a second MT may comprise a SUPI_B. The first MT and the second MT may be served by a first VPLMN.

Due to a condition (for example at least one of a steering mode can no longer be supported, MT moves out of coverage, the QoS drops, or the slice becomes unavailable and others), a DualSteer WTRU may trigger one of the first or second MTs to search and select another PLMN, e.g. a second VPLMN. The session for one or both MTs may be handed over to the second PLMN before the connection is lost.

In certain representative embodiments, a first MT may comprise a SUPI_A, The first MT may comprise a PDU session with a first HPLMN or VPLMN and a second MT may comprise a SUPI_B. The second MT may comprise a PDU session with a second VPLMN. The second MT may experience a condition (for example at least one of a steering mode can no longer be supported, MT moves out of coverage, the QoS drops, or the slice becomes unavailable and others). The second MT may be triggered to search and select another PLMN, for example the first HPLMN or VPLMN, to establish a new session. While doing so, the second MT may request traffic to be put on hold/stand-by or the second MT may request to move the on-going traffic to the first MT in the DualSteer WTRU.

In certain representative embodiments, in a roaming scenario a home-routed roaming is provided.

In certain representative embodiments, a procedure to trigger PDU session management in roaming scenarios, i.e., release, handover, or modification, based on a trigger such as QoS drop, out-of-coverage etc. is provided.

In certain representative embodiments, one MT may be enabled to register and request PDU session on behalf of two MTs within a DualSteer WTRU.

In certain representative embodiments, methods to suspend, move or pause a PDU session based on a condition and requirements for one of the MTs within a DualSteer WTRU are provided.

### PDU Session Handover for a DualSteer Device—Scenario 1

In certain representative embodiments, a roaming scenario is provided. In the roaming scenario, a DualSteer capable WTRU may comprise a first MT and a second MT. In certain other representative embodiments, the DualSteer capable WTRU may comprise a first UE and a second UE.

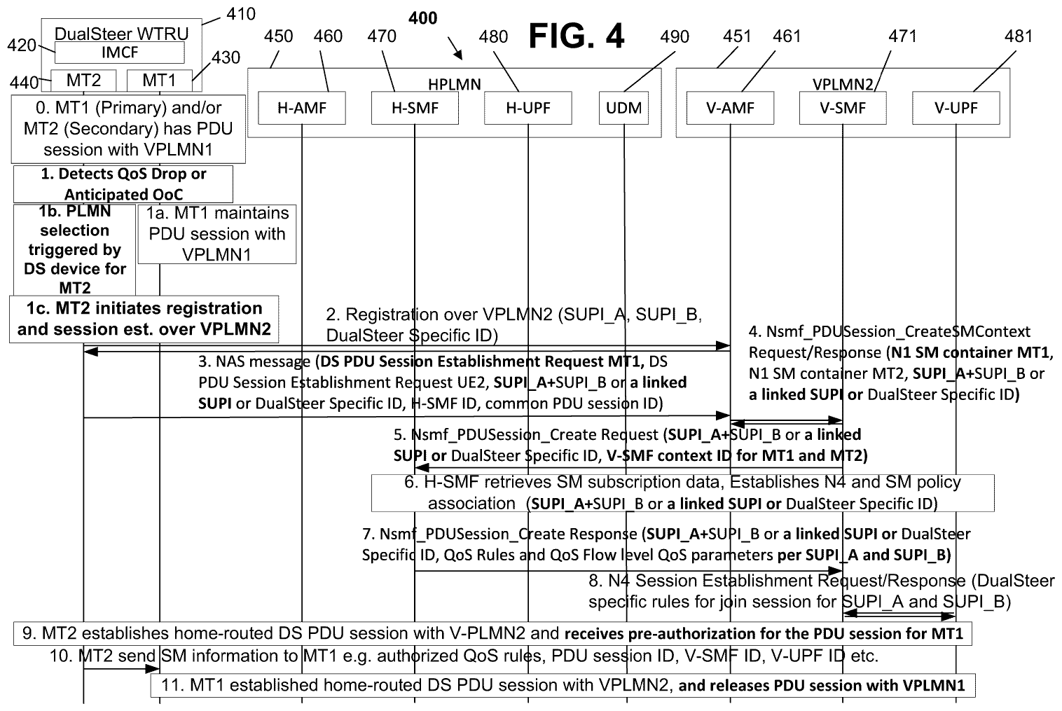

In certain representative embodiments, a PDU session handover for a DualSteer WTRU is provided. For example, FIG. 4 is a sequence diagram illustrating an example of a PDU session handover for a DualSteer WTRU. In certain representative embodiments, a process 400 is provided. The process 400 may include one or more communications between one or more of a DualSteer WTRU 410, an IMCF 420 of the DualSteer WTRU 410, a first MT (MT1) 430 of the DualSteer WTRU 410, a second MT (MT2) 440 of the DualSteer WTRU 410, a HPLMN 450, an H-AMF 460 of the HPLMN 450, an H-SMF 470 of the HPLMN 450, an H-UPF 480 of the HPLMN 450, a UDM 490 of the HPLMN 450, a VPLMN (VPLMN2) 451, an V-AMF 461 of the VPLMN2 451, a V-SMF 472 of the VPLMN2 451, a V-UPF 481 of the VPLMN2 452. The process 400 may include one or more steps.

The MT1 430 may be a primary MT and the MT2 430 may be a secondary MT. The MT1 430 and/or MT2 440 may have established a home-routed PDU sessions via VPLMN1 (not shown) to HPLMN 450. i.e., the same VPLMN for both MTs but different access. There may be an on-going communication either on both legs, i.e., simultaneous data transfer, or either of the two legs, i.e., non-simultaneous data transfer.

The MT2 440 may notice a condition such as QoS has dropped, and may anticipate that the MT2 may experience coverage loss, the slice become unavailable, and/or the steering mode is not supported. In such a situation, the DualSteer WTRU 410 may trigger the MT2 440 to release its on-going PDU session, then search and select another PLMN, e.g., the VPLMN2 451, before going out of coverage of the VPLMN1. The MT1 in the DualSteer WTRU 410 may maintain its PDU sessions with the VPLMN1 410 in the meantime. In other words, a new connection may be established before the MT2 440 loses its connection, by utilizing the fact that there are two MTs within the DualSteer WTRU 410.

The process 400 may include Step 0. In Step 0, both MT1 and MT2 may have their PDU sessions established with the HPLMN 450 via the VPLMN1, i.e., home-routed PDU sessions, where the H-SMF 470 and the H-UPF 480 may be the anchor points for both MTs (the MT1 430 and the MT2 440) in the HPLMN 450.

The process 400 may include Step 1. In Step 1, the DualSteer WTRU 410 may monitor and analyze at least one of the following conditions: QoS drops below a threshold, Prediction of an MT losing the coverage and/or being in an out-of-coverage scenario, Slice becomes unavailable, Service area incompatible/restricted, ATSSS steering modes (Active-Standby, Smallest delay, Load Balancing, Priority-based) and others.

In certain representative embodiments, a coordination function within the DualSteer WTRU 410 as explained in the above sections, an application, or a connectivity manager configured to make the decision based on DualSteer connectivity policy, may be used to configure the conditions to monitor. The conditions may include thresholds (min. max values), intended behaviors (release PDU session and de-register, disconnect and initiate new PLMN search and so forth).

When the DualSteer WTRU 410, based on above conditions and DualSteer connectivity policy, detects that one of the conditions is true, e.g., QoS falls below a threshold, then it may perform at least one of the following:

At Step 1a: the DualSteer WTRU 410 may allow one of the MTs, e.g., the MT1 430 which may be a primary MT or secondary MT, to maintain its PDU session with the VPLMN1. The DualSteer WTRU 410 may make this decision based on at least one of the following configurations:

The DualSteer WTRU 410 may be configured with a policy rule provided in the PDU session establishment of Step 0 or in a UE Route Selection Policy (URSP), which indicates which MTs PDU session may be maintained;
The DualSteer WTRU 410 may be configured to always maintain PDU session of the MT1 430;
The DualSteer WTRU 410 may be configured to always maintain PDU session of the MT2 440;
The DualSteer WTRU 410 may be configured to always maintain PDU session of primary MT;
The DualSteer WTRU 410 may be configured to always maintain PDU session of secondary MT;
The DualSteer WTRU 410 may choose to maintain the PDU session of an MT which has better signal quality to its RAN node.

At Step 1b: The DualSteer WTRU 410 may trigger the other MT, e.g., the MT2 440, to perform PLMN Search and selection. The MT2 440 may select a PLMN from the list of high-priority PLMN authorized for DualSteer service. The DualSteer WTRU 410 may suggest to the MT2 that VPLMN1 should not be selected again. Since, the roaming scenario with home-routing is provided, thus the HPLMN 450 is not available for selection.

At Step 1c: the MT2 440 may, based on the trigger, initiate registration and session establishment with a selected PLMN, e.g., the VPLMN2 451. The MT2 440 may perform registration and request a DualSteer PDU session for both MTs.

The process 400 may include Step 2. In Step 2, the MT2 440 may perform registration with the VPLMN2 451. A registration request may be for both the MT1 430 and MT2 440, i.e., MT2 440 may register and include an DualSteer specific ID, DualSteer session ID, and/or a MT1 ID such as SUPI or 5G-GUTI. When the MT2 440 is triggered in Step 1c, the DualSteer WTRU 440 (for example the coordination function) may provide relevant information of the MT1 430 to the MT2 440. The MT2 440 in the initial registration message may encapsulate the information of the MT1 430 in addition to the information of the MT2 440, which may include SUPI_A or 5G-GUTI_A, SUPI_B or 5G-GUTI_B, MT1 (or UE1) DualSteer capability, MT2 (or UE2) DualSteer capability.

The DualSteer WTRU 410 may comprise a DualSteer capability which may indicate whether the DualSteer has single MT (i.e. UE) with two-USIMs or two separate MTs (i.e. UEs) for two-USIMs, implying whether non-simultaneous or simultaneous data transmission is supported. For two separate MTs example, each MT may have different capabilities and may support some or all steering modes due to subscription, allowed RAT etc. Therefore, both MT1 430 and MT2 440 may have different DualSteer capabilities which may be provided as part of registration message.

The DualSteer WTRU 410 may determine whether to include the request for the MT1 430 based on some policy provided in the PDU session establishment of Step 0. Alternatively, the DualSteer WTRU 410 may determine not to include the registration request from the MT1 430 if the signal quality for the MT1 430 is above a threshold.

In certain representative embodiments, both the MT1 430 and MT2 440 may belong to the same HPLMN 450. If the MT1 430 and MT2 440 belong to two different HPLMN, e.g., HPLMN1 and HPLMN2, then a V-PCF may reach out to H-PCF1 and H-PCF2 for the MT1 and MT2 430,440 for the policy association establishment, respectively. A DualSteer WTRU may receive policy updates including the DualSteer specific URSP rules for each MT from its respective H-PCF.

The process 400 may include Step 3. In Step 3, the MT2 440 may send a NAS transport message to the V-AMF 461 to request PDU session establishment. The PDU session establishment request sent by MT2 440 may be to establish a DualSteer PDU sessions for both the MT1 430 and MT2 440, which in other words correspond to a DualSteer PDU session that is for both MT1 430 and MT2 440.

The NAS message may include at least one of: a DualSteer specific ID, a common PDU session ID, the MT2 440 (i.e. UE2) specific parameters, e.g., SUPI_B, N1 SM container2 (PDU session establishment requests for the MT2 440, PDU session ID corresponding to SUPI_B, MT2 440 DualSteer capability), H-SMF2 ID, H-UPF2 ID, and MT1 430 (i.e. UE1) specific parameters, e.g., SUPI_A, N1 SM container1 (PDU session establishment requests for MT1 430 PDU session ID corresponding to SUPI_A, MT1 DualSteer capability), H-SMF1 ID, H-UPF1 ID.

In certain representative embodiments, both the MT1 430 and the MT2 440 may belong to the same HPLMN 450, then the H-SMF1 and H-SMF2, and H-UPF1 and H-UPF2 refer to the same network functions in the HPLMN 450. In certain representative embodiments, the MT1 430 and the MT2 440 may belong to two different HPLMN, e.g., HPLMN1 and HPLMN2, then the H-SMF1 and H-SMF2, and H-UPF1 and H-UPF2 are not the same. In this case, H-SMF1 and H-SMF2 may exchange DualSteer rules over N16 and H-UPF1 and H-UPF2 may exchange data over N9 interface, while only one of them has connection with the DN.

Moreover, PDU session ID corresponding to SUPI_A and SUPI_B may be the IDs of the PDU session of the MT1 430 and the MT2 440, respectively, which are part of the DualSteer session.

The process 400 may include Step 4. In Step 4, the V-AMF 461 may select the V-SMF 471 and send/receive Nsmf_PDUSession_CreateSMContext Request/response message including the PDU session establishment request and information for both the MT1 430 and MT2 440 as described in Step 3.

The process 400 may include Step 5. In Step 5, the V-SMF 471 may send Nsmf_PDUSession_Create Request message to the H-SMF 470. In certain representative embodiments, the message may be send to each of the H-SMF1 and H-SMF2 (assuming H-SMF1 is the same as H-SMF2 in case of same HPLMN for both MTs), and provides the MT1 430 and MT2 440 parameters including N1 SM container MT1, N1 SM container MT2, SUPI_A, SUPI_B, DualSteer Specific ID, Common PDU session ID, MT1 DualSteer capability, MT2 DualSteer capability.

The process 400 may include Step 6. In Step 6, the MT1 430 may have a PDU session established with the H-SMF 470 via the VPLMN1 and the MT1 430 and MT2 440 may belong to the same HPLMN 560. In this case, the H-SMF 580 may already have SM context established for the MT1 430.

The H-SMF 470 may perform several procedures:

The H-SMF 470 may retrieve the SM subscription data in the UDM for both SUPI_A and SUPI_B, determine their linkage and check whether DualSteer is allowed or not for both MTs.

The H-SMF 470 may select PCF that is DualSteer capable and perform SM policy association with H-PCF for both MTs by including parameters for both MTs in the request message.

The H-SMF 470 may select UPF, which would be the same as existing PDU session for the MT1 430.

In certain other representative embodiments, the MT1 430 and MT2 440 may not belong to the same HPLMN, in that case when the request is sent to the H-SMF2 that includes a MT1 ID and an ID of the DualSteer session, H-SMF2 may coordinate with H-SMF1 to request SM context for the MT1 430, and vice versa as the H-SMF1 ID and H-SMF2 ID may be provided in the initial request at step 3.

The process 400 may include Step 7. In Step 7, the V-SMF 471 may receive Nsmf_PDUSession_Create Response message from H-SMF1 and H-SMF2, SUPI_A, SUPI_B, DualSteer Specific ID, QoS Rules and QoS Flow level QoS parameters per SUPI_A and SUPI_B for both the MT1 430 and MT2 440.

The process 400 may include Step 8. In Step 8, the V-SMF 471 may establish N4 session with V-PCF for the MT1 430 and the MT2 440.

The process 400 may include Step 9. In Step 9, the MT2 440 may establish a home-routed DualSteer PDU session over the V-PLMN2 451. The MT2 440 may also receive pre-authorization for DualSteer PDU session for the MT1 430, which includes parameters required for the MT1 430 to establish a PDU session with the VPLMN2 451. It may be QoS Rules and QoS Flow level QoS parameters, N1 SM container, V-SMF ID, V-UPF ID and a validity timer value.

The process 400 may include Step 10. In Step 10, the MT2 may send SM information to the MT1 430, e.g., authorized QoS rules, PDU session ID, V-AMF ID, V-SMF ID, V-UPF ID etc., directly or via coordination function within the DualSteer WRTU 410.

The process 400 may include Step 11. In Step 11, the MT1 430 may release its PDU session with the VPLMN1 and establishes a home-routed PDU session over the VPLMN2 451.

The timer value provided in Step 9 may determine the validity of parameters, and if it expires the MT1 430 may refuse the PDU session setup to the VLPMN2 451. In certain representative embodiments, the network may also have a timer and disregard the pre-authorization if the timer expires and optionally the expiration may be an indication that the MT1 may remain connected with the VPLMN1.

### PDU Session Handover for a DualSteer WTRU—Scenario 2

In certain representative embodiments, another roaming scenario is provided. A first MT may comprise a SUPI_A and may have a PDU session with a first HPLMN or VPLMN and a second MT may comprise SUPI_B and may have PDU session with a second VPLMN. The second MT (MT2) may experience a condition as explained in the above paragraphs, and may be triggered to search and select another PLMN, e.g., the first HPLMN or VPLMN, to establish a new session. In certain representative embodiments, while the MT2 search and selects another PLMN, it may request the traffic over the MT2 to be put on hold/stand-by or it may request to move the on-going traffic to the other MT in the DualSteer WTRU, e.g., from the MT2 to the MT1.

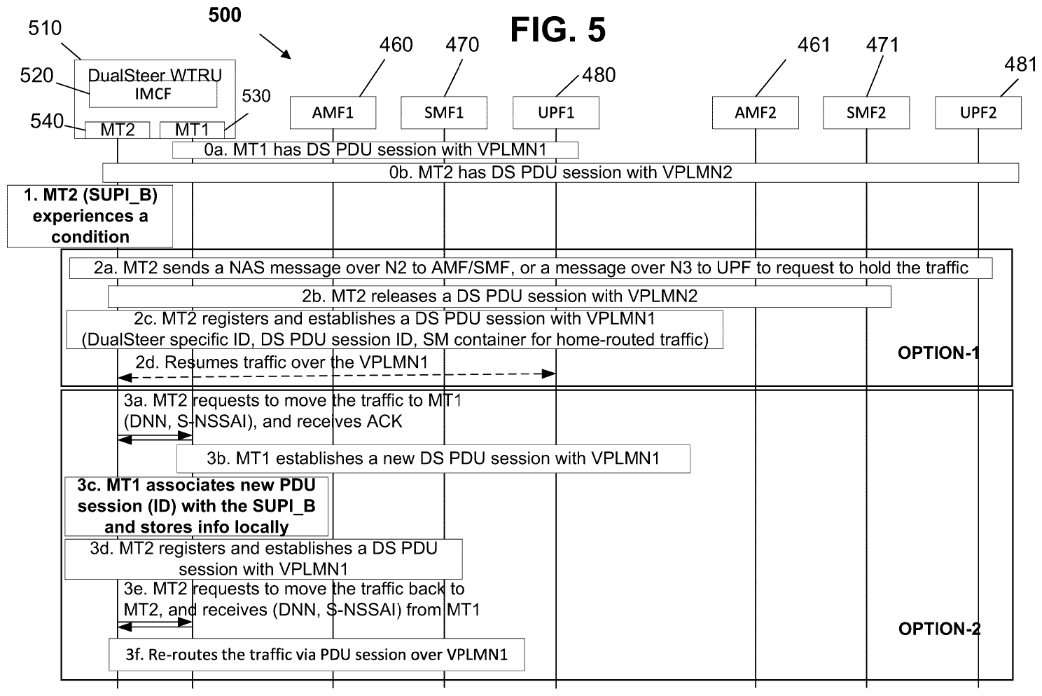

In certain representative embodiments, a PDU session handover for a DualSteer WTRU is provided. For example, FIG. 5 is a sequence diagram illustrating an example of a PDU session handover for a DualSteer WTRU. In certain representative embodiments, a process 500 is provided. The process 500 may include one or more communications between one or more of a DualSteer WTRU 510, an IMCF 520 of the DualSteer WTRU 510, a first MT (MT1) 530 of the DualSteer WTRU 510, a second MT (MT2) 540 of the DualSteer WTRU 510, a first VPLMN (VPLMN1) (not shown), an AMF1 560 of the VPLMN1, an SMF1 570 of the VPLMN1, an UPF1 580 of the VPLMN1, a second VPLMN (VPLMN2) (not shown), an AMF2 561 of the VPLMN2, a SMF2 572 of the VPLMN2, a UPF2 581 of the VPLMN2. The process 500 may include one or more steps.

In certain representative embodiments, the MT1 530 may have an on-going data transmission, while MT2 540 may be for back-up (for example ATSSS steering mode Active-standby). In this case, the MT2 may easily be triggered to establish connection with the VPLMN2 while PDU session is maintained by the MT1 530 with the VPLMN1. In certain representative embodiments, both the MT1 530 and the MT2 540 may have an on-going data transmission simultaneously, in this case following the ATSSS rules, the DualSteer WTRU 510 may need to move the flows of the MT2 540 to the MT1 530, and then disconnect the MT2 540 from the VPLMN1 before re-establishing a connection with another PLMN.

The process 500 may include Step 0a. In Step 0a, the MT1 530 may have a home-routed DualSteer PDU session established over the VPLMN1.

The process 500 may include Step 0b. In Step 0b, the MT2 540 may have a home-routed DualSteer PDU session established over the VPLMN2.

The process 500 may include Step 1. In Step 1, the DualSteer WTRU 510 may monitor and analyze at least one of the following conditions: QoS drops below a threshold, a prediction that an MT may lose the coverage and/or out-of-coverage scenarios, Slice becomes unavailable, Service area incompatible/restricted, ATSSS steering modes (Active-Standby, Smallest delay, Load Balancing, Priority-based) and others.

The DualSteer WTRU 510, for example a coordination function within the DualSteer WTRU 510 as explained in the above paragraphs, an application, or a connectivity manager which may make the decision, detects that one of the conditions is true, e.g., QoS falls below a threshold, for the MT2 540. This may indicate that the MT2 540 may lose its connection shortly or QoS has dropped, and the MT2 540 do not meet the QoS requirements.

In certain representative embodiments, network conditions may cause the traffic switch. In certain representative embodiments, the ATSSS steering modes following steering mode may rule to switch the traffic. In certain representative embodiments, network conditions and the ATSSS steering modes following steering mode may cause the switch of the traffic. For ATSSS steering modes there may be specific set of rules defined that enable automatic steering of traffic to a better leg. In certain representative embodiments, the network conditions quality of service over leg may be so poor that the DualSteer WTRU 510 may decide to move the PDU session.

The process 500 may include at least one or more of steps described in option 1 and/or option 2. Option 1 may include steps 2a to 2d as described below and option 2 may include steps 3a to 3f as described below.

The process 500 may include Step 2a. In Step 2a, the MT2 540 may send a NAS message over N2 to AMF/SMF, or a message over N3 to UPF, or an application layer message to hold/stand-by the traffic.

The process 500 may include Step 2b. In Step 2b, the MT2 540 may initiate the PDU session release procedure with the VPLMN2 and perform de-registration the VPLMN2.

The process 500 may include Step 2c. In Step 2c, the MT2 540 may register and establish a PDU session over another PLMN, e.g., the VPLMN1.

The process 500 may include Step 2d. In Step 2d, the MT2 may resume the traffic over the VPLMN1.

The process 500 may include Step 3a. In Step 3a, the MT2 may request to move the traffic to the MT1 530 (DNN, S-NSSAI) and receive ACK from the MT1 530 if request is accepted by the MT1 530. The MT2 540 may initiate the PDU session release procedure upon acceptance from the MT1 530.

The process 500 may include Step 3b. In Step 3b the MT1 may establish a new PDU session with the VPLMN1, where the MT1 530 may be already connected.

The process 500 may include Step 3c. In Step 3c, the MT1 530 may associate new PDU session using PDU session ID with the SUPI_B (MT2) and stores this information locally or notify this to the coordination function.

The process 500 may include Step 3d. In Step 3d, the MT2 540 may register and establish a PDU session over another PLMN, e.g., the VPLMN1.

The process 500 may include Step 3e. In Step 3e, the MT2 540 may request to move the traffic back to the MT2 540 from the MT1 530. The MT1 530 may accept or reject the request, if accepted then it may provide DNN, S-NSSAI to the MT2 540.

The process 500 may include Step 3f. In Step 3f, the traffic is re-routed via PDU session over the VPLMN1.

In certain representative embodiments, the Dualsteer WTRU 510 may decide to pause PDU session over the MT2 540, once the traffic is successfully transferred from the MT2 540 to the MT1 530. The Dualsteer WRTU 510 may decide to transfer the PDU session to another PLMN or RAT combination based on the requirements.

In certain representative embodiments, the process 500 may only include at least one of steps 0a to 2d but not include steps 3a to 3f. In certain representative embodiments, the process 500 may only include at least one of steps 0a to 1 and 3a to 3f but not include steps 2a to 2d. In certain representative embodiments, the process 500 may include all steps 0a to 3f. In certain representative embodiments, the process 500 may include any combination of steps 0a to 3f.

In certain representative embodiments, a DualSteer WTRU may comprise a first MT and a second MT. The first MT and the second MT may have PDU session established with a first VPLMN.

In certain representative embodiments, the DualSteer WTRU may notice a condition, e.g., QoS drop or anticipate out-of-service (OoS) etc. then based on a DualSteer connectivity policy.

In certain representative embodiments, the DualSteer WTUR may decide for the first MT to maintain its PDU session with the first VPLMN.

In certain representative embodiments, the DualSteer WTUR may trigger the second MT to perform PLMN Search and selection. The second MT may select a second VPLMN from a list of high-priority PLMN or any available PLMN except the first VPLMN. The first VPLMN may be marked as lowest priority PLMN for the second MT for the purpose of search and selection.

In certain representative embodiments, the DualSteer WTRU may move the second MT's on-going PDU session to the first MT or may release them before initiating the registration process to a new PLMN, e.g. the second VPLMN.

In certain representative embodiments, DualSteer WTRU may decide for the second MT to initiate registration and session establishment with the second VPLMN.

In certain representative embodiments, the second MT may register over the second VPLMN for the first MT and the second MT, where registration message may include information of the first MT in addition to the second MT's own information.

In certain representative embodiments, the second MT may request DualSteer PDU session for the second MT and for the first MT and may include a combined DualSteer PDU session establishment request corresponding to SUPI_A (MT1) and SUPI_B (MT2).

In certain representative embodiments, the second MT may establish a home-routed DS PDU session over the second VPLMN, and may also obtain pre-authorization for the first MT. The first MT (via the second MT) may receive authorization and parameters (N1 SM container, QoS rules, DualSteer PDU session ID etc.) from the network (HPLMN) to establish a home-route DualSteer PDU session.

In certain representative embodiments, the second MT may send SM information to the first MT via coordination function or directly. The information may include authorized QoS rules, PDU session ID, V-AMF ID, V-SMF ID, V-UPF ID etc.

In certain representative embodiments, the first MT may initiate PDU session release procedure and de-registration procedure with the first VPLMN, before establishing a PDU session with the second VPLMN.

In certain representative embodiments, a first MT and a second MT may have their PDU session established with a first VPLMN and a second VPLMN:

In certain representative embodiments, the second MT in a DualSteer WTRU may notice a condition with the second VPLMN, e.g., QoS drop or anticipate OoS.

In certain representative embodiments, the second MT may send a NAS message, or a message over N3 to UPF, or an application layer message to request hold or stand-by the traffic.

In certain representative embodiments, the second MT may initiate the PDU session release procedure with the second VPLMN and perform de-registration from the second VPLMN.

In certain representative embodiments, the second MT may register and establish a PDU session over another PLMN, e.g., the first VPLMN.

In certain representative embodiments, the second MT may resume the traffic over the first VPLMN.

In certain representative embodiments, the second MT may request to move the traffic to the first MT (DNN, S-NSSAI) and receive ACK from the first MT if request is accepted by the first MT. The second MT may initiate the PDU session release procedure upon acceptance from the first MT.

In certain representative embodiments the first MT may establish a new PDU session with the first VPLMN, where the first MT may be already connected.

In certain representative embodiments, the first MT may associate new PDU session using PDU session ID with the SUPI_B (MT22) and may store this information locally or notify this to the coordination function.

In certain representative embodiments, the second MT may register and establish a PDU session over another PLMN, e.g., the first VPLMN.

In certain representative embodiments, the second MT may request to move the traffic back to the second MT from the first MT. The first MT may accept or reject the request, if accepted then it may provide DNN, S-NSSAI to the second MT.

In certain representative embodiments, a method according to one or more embodiments is performed by a device comprising a first mobile termination (MT) and a second MT. For example, the first MT and the second MT may be each in a protocol data unit (PDU) session with a network. The device may be one device or plural devices.

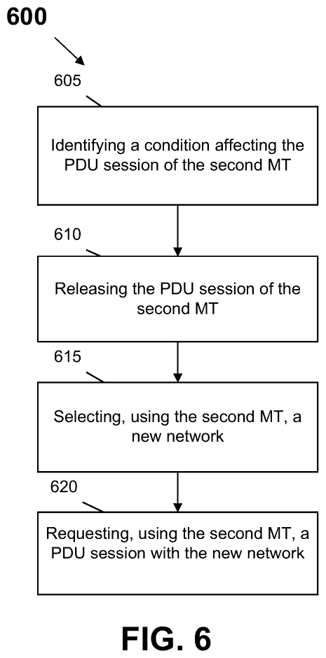

For example, FIG. 6 is a procedural diagram illustrating a method 600 for PDU session management according to one or more embodiments. The method 600 may be performed by a wireless transmit/receive unit (WTRU) comprising a first mobile termination (MT) and a second MT. The first MT and second MT may be each in a protocol data unit (PDU) session with a network. The method 600 may include identifying 605 a condition affecting the PDU session of the second MT. In response to identifying the condition, the method 600 may include releasing 610 the PDU session of the second MT. The method 600 may include selecting 615, using the second MT, a new network. The method 600 may include requesting 620, using the second MT, a PDU session with the new network.

In some implementations, the WTRU may be configured to perform the identifying 605 the condition affecting the PDU session of the second MT. In some implementations, the second MT may be configured to perform the releasing 610 the PDU session of the second MT the selecting 615 the new network and the requesting 620 the PDU session with the new network.

In some implementations, the condition may comprise at least one of: a quality of service metric being below a threshold; or a prediction the MT may lose coverage.

In some implementations, the first MT maintains its PDU session while the second MT releases its PDU session and selects the new network.

In some implementations, the first MT may be in its PDU session with a first network; the second MT may be in its PDU session with the first network; and the condition may affect the PDU sessions of both the first MT and the second MT.

In some implementations, a PDU session with the new network is established using the second MT; and after the second MT establishes the PDU session with the new network, the PDU session of the first MT is released.

In some implementations, the second MT is selected to release its PDU session based on signal quality.

In some implementations, requesting the PDU session with the new network may comprise requesting, using the second MT, PDU sessions for the first MT and the second MT in a non-access stratum (NAS) message; and the NAS message may comprise a first subscription permanent identifier for the first MT; and a second subscription permanent identifier for the second MT.

In some implementations, pre-authorization information may be received, using the second MT, for a PDU session for the first MT with the new network; and the pre-authorization information may be sent, using the second MT, to the first MT.

In some implementations, the first MT may be in its PDU session with a first network; the second MT may be in its PDU session with a second network different than the first network.

In some implementations, in response to identifying the condition, traffic of the second MT may be requested to be moved to the first MT by the second MT; and in response to the second MT receiving an acknowledgement that the request to move the traffic of the second MT is accepted, the releasing of the PDU session of the second MT may be performed.

In some implementations, a PDU session may be established, using the second MT, with the new network; and after the second MT establishes the PDU session with the new network, requesting, by the second MT, to move the traffic back to the second MT.

In some implementations, in response to identifying the condition, the second MT may request the traffic of the second MT to be put on one of hold or standby.

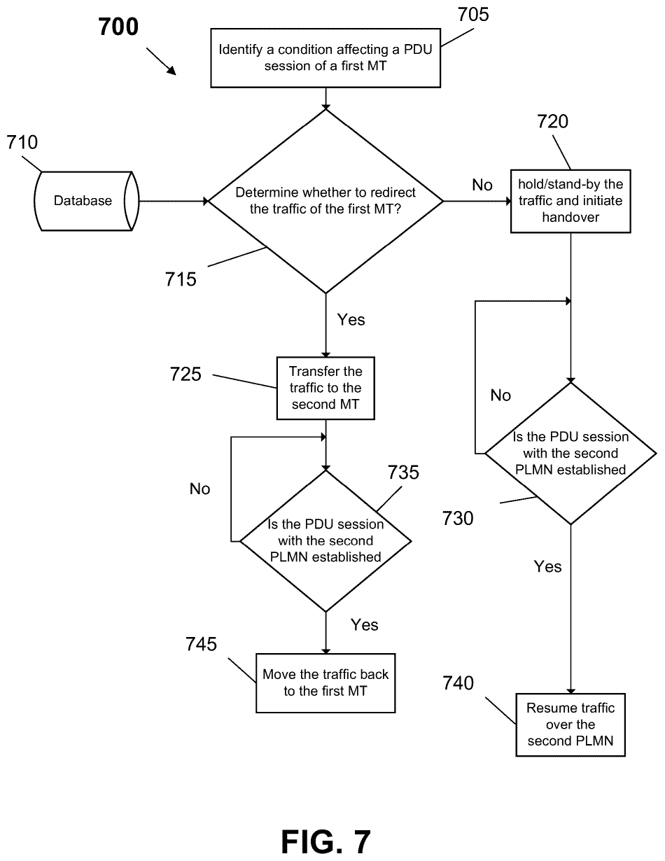

FIG. 7 is a procedural diagram illustrating a process for traffic management according to one or more embodiments. At step 705, the process 700 may include identify a condition affecting a PDU session of a first MT of a DualSteer WTRU. The DualSteer WTRU may comprise the first MT and a second MT. The first MT and second MT may be each in a protocol data unit (PDU) session with a network. The condition may be at least one of a steering mode can no longer be supported, the first MT moves out of coverage, a QoS drops, or a Slice becomes unavailable and/or others. At step 715, the process 700 may include determining whether a traffic of the first MT originating from a database 710 should be redirected to the second MT. The determination may be based on a requirement of the traffic. The requirement may be a QoS defined for the traffic and/or a characteristic of data in the traffic (for example data requiring uninterrupted transmission). For example, the determination may be based on whether the second MT is capable of meeting the QoS defined for the traffic. If it is determined not to redirect the traffic, at step 720, the traffic to the first MT may be paused or held on stand-by and the first MT may initiate a handover. The handover may include the first MT initiating the PDU session release procedure with a first PLMN and perform de-registration with the first PLMN and register and establish a PDU session over a second PLMN. At step 730, the process 700 may include determining whether the PDU session with the second PLMN is established. If it is determined that the PDU session with the second PLMN is established, at step 740, the first MT may resume traffic over the second PLMN. If it is determined that the PDU session with the second PLMN is not established, the process 700 may return to step 730. If it is determined to redirect the traffic at step 715, at step 725, the process may include transferring the traffic to the second MT. The transferring the traffic to the second MT may be in accordance with the transfer procedure described in FIGS. 3 and 4. The first MT may initiate a handover. The handover may include the first MT initiating the PDU session release procedure with the first PLMN and perform de-registration with the first PLMN and register and establish a PDU session over a second PLMN. At step 735, the process 700 may include determining whether the PDU session with the second PLMN is established. If it is determined that the PDU session with the second PLMN is established, at step 745, the traffic may be moved back to the first MT over the second PLMN. If it is determined that the PDU session with the second PLMN is not established, the process 700 may return to step 735.

Each of the contents of the following references is incorporated by reference herein in their entireties: [1]3GPP SP-231802, New SID on Multi-Access (DualSteer and ATSSS_Ph4). [2]3GPP TR 23.700-54, Study on Multi-Access (DualSteer and ATSSS_Ph4) (Release 19), V0.2.0. TS 23.501, System architecture for the 5G System (5GS), V18.2.2. [4] TS 23.502, Procedures for the 5G System (5GS), 18.2.0. [5] TS 23.122, Non-Access-Stratum (NAS) functions related to Mobile Station (MS) in idle mode, V18.3.1. [6] TS 38.300, NR; NR and NG-RAN Overall description; Stage-2, V17.5.0. [7]3GPP S2-2402960, DualSteer Solution for KIs 1.1, 1.2, 1.x (policies), 1.y (session establishment): DualSteer Protocol Stack model.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU) comprising a first mobile termination (MT) and a second MT, wherein the first MT and second MT are each in a protocol data unit (PDU) session with a network, the method comprising:
identifying a condition affecting the PDU session of the second MT; and
in response to identifying the condition:
releasing the PDU session of the second MT;
selecting, using the second MT, a new network; and
requesting, using the second MT, a PDU session with the new network.

2. The method of claim 1, wherein the condition comprises one of:
a quality of service metric being below a threshold; or
a prediction the MT may lose coverage.

3. The method of claim 1, wherein the first MT maintains its PDU session while the second MT releases its PDU session and selects the new network.

4. The method of claim 1, wherein:
the first MT is in its PDU session with a first network;
the second MT is in its PDU session with the first network; and
the condition affects the PDU sessions of both the first MT and the second MT.

5. The method of claim 4, further comprising:
establishing, using the second MT, a PDU session with the new network; and
after the second MT establishes the PDU session with the new network, releasing the PDU session of the first MT.

6. The method of claim 1, further comprising:
selecting the second MT to release its PDU session based on a condition.

7. The method of claim 1, wherein:
requesting the PDU session with the new network comprises requesting, using the second MT, PDU sessions for the first MT and the second MT in a non-access stratum (NAS) message; and
the NAS message comprises:
a first subscription permanent identifier for the first MT; and
a second subscription permanent identifier for the second MT;

8. The method of claim 7, further comprising:
receiving, using the second MT, pre-authorization information for a PDU session for the first MT with the new network; and
sending, using the second MT, the pre-authorization information to the first MT directly or via a coordination function within the WRTU.

9. The method of claim 1, wherein:
the first MT is in its PDU session with a first network;
the second MT is in its PDU session with a second network different than the first network.

10. The method of claim 9, further comprising:
in response to identifying the condition, requesting, by the second MT, traffic of the second MT to be moved to the first MT; and
in response to the second MT receiving an acknowledgement that the request to move the traffic of the second MT is accepted, performing the releasing of the PDU session of the second MT.

11. The method of claim 10, further comprising:
establishing, using the second MT, a PDU session with the new network; and
after the second MT establishes the PDU session with the new network, requesting, by the second MT, to move the traffic back to the second MT.

12. The method of claim 9, further comprising:
in response to identifying the condition, requesting, by the second MT, traffic of the second MT to be put on one of hold or standby.

13. A wireless transmit/receive unit (WTRU) comprising:
a first mobile termination (MT); and
a second MT, wherein:
the first MT and second MT are each in a protocol data unit (PDU) session with a network;
the WTRU is configured to identify a condition affecting the PDU session of the second MT; and
the second MT is configured to, after the condition is identified:
release its PDU session;
select a new network; and
request a PDU session with the new network.

14. The WTRU of claim 13, wherein the condition comprises one of:
a quality of service metric being below a threshold; or
a prediction the MT may lose coverage.

15. The WTRU of claim 13, wherein the first MT maintains its PDU session while the second MT releases its PDU session and selects the new network.

16. The WTRU of claim 13, wherein:
the first MT is in its PDU session with a first network;
the second MT is in its PDU session with the first network; and
the condition affects the PDU sessions of both the first MT and the second MT.

17. The WTRU of claim 16, wherein:
the second MT is configured to establish a PDU session with the new network; and
after the second MT establishes the PDU session with the new network, the WTRU releases the PDU session of the first MT.

18. The WTRU of claim 13, wherein:
the first MT is in its PDU session with a first network;
the second MT is in its PDU session with a second network different than the first network.

19. The WTRU of claim 18, wherein:
in response to identifying the condition, the second MT is configured to request traffic of the second MT to be moved to the first MT; and
in response to the second MT receiving an acknowledgement that the request to move the traffic of the second MT is accepted, the WTRU is configured to perform the releasing of the PDU session of the second MT.

20. The WTRU of claim 19, wherein:
the second MT is configured to:
establish a PDU session with the new network; and
after the second MT establishes the PDU session with the new network, request to move the traffic back to the second MT.
